(19) United States
(12) Patent Application Publication
(10) Pub. No.: US 2005/0046136 A1
(43) Pub. Date: Mar. 3, 2005

(54) Four-link vehicle suspension system

(76) Inventor: Guy Sutton, Catherine de Barnes (GB)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/929,669

(22) Filed: Aug. 30, 2004

(30) Foreign Application Priority Data
Aug. 30, 2003 (GB) 0320421.1

(51) Int. Cl. B60G 1/00

(52) U.S. Cl. 280/124.135

(57) ABSTRACT

A multi-linked suspension arrangement suitable for the rear wheel of a vehicle comprises an upper wishbone, two transverse links, and a forwardly extending lower longitudinal link. The geometry minimises hub rotation during braking while minimizing packaging space and maximising rear seat and boot space.

### BACKGROUND OF THE INVENTION

The present invention relates to multi-link suspension systems for wheeled vehicles. A wheel suspension's function is, primarily, to isolate the vehicle body and its occupants from the road. However, a suspension system must also control the wheel relative to the vehicle body during braking, cornering and acceleration. These two requirements conflict to a certain extent and usually a compromise has to be made between comfort and road-holding.

One particular problem addressed by the present invention is that of minimizing the twisting forces about the wheel axle that are induced under braking or when a wheel hits a bump in the road surface.

US 57,658,58 describes a four-link suspension system which aims to provide improved stability over rough terrain. The systems includes an upper arm, front and rear lateral links and a forwardly extending radius rod. The rear lateral link supports a coil spring while a shock absorber is separately supported on the axle housing so that a compression (or expansion) stroke of the shock absorber does not affect “wind-up” forces applied to the axle housing by the coil spring.

EP-A-1123821 discloses a five-link suspension system which aims to avoid significant longitudinal spring travel in the rubber mounts of the links due to “wind-up” effects during braking. The system comprises three transverse links and two longitudinal links for connecting a wheel carrier to the vehicle body. One longitudinal link extends forwards from the wheel carrier and the other longitudinal link extends rearwards from the wheel carrier. The separation of the wheel centre from the wheel carrier attachment point of the forward longitudinal link (measured in the vertical direction) is greater than the distance from said attachment point to the ground. This ensures a favourable relationship between forces and moments.

While these known systems might provide reasonable ride and handling characteristics in certain circumstances, they have the disadvantage of taking up a lot of space.

### SUMMARY OF THE INVENTION

In accordance with a first aspect, the present invention provides a suspension system for a wheeled vehicle, said system comprising four links for connecting a wheel carrier to the vehicle, wherein said links comprise an upper arm, two transverse links and a longitudinal link which extends forwardly of the wheel carrier, and characterised in that the distance between the wheel carrier attachment point of the longitudinal link and wheel centre measured in the vertical direction is greater than the distance between said attachment point and the point of contact of the wheel and the ground.

In accordance with a second aspect, the present invention provides a wheeled vehicle incorporating the suspension system in accordance with the first aspect.

By adjusting the distances between the longitudinal link's attachment point and wheel centre and this attachment point and the ground, the invention provides the advantage over the known four-link arrangement mentioned above of minimizing unwanted “wind up” movements. That is to say that this characterising feature lessens the torque around the effective centre of rotation of the wheel carrier (hub) under braking forces or when the wheel hits a bump. This feature provides the desirable characteristics of a low recession rate (i.e. a low compliance fore and aft) and a high stiffness at the tyre contact patch.

Preferably, the upper arm is a transverse upper wishbone, attached to the wheel carrier above wheel centre. The use of an upper wishbone link gives reduced levels of wheel carrier (or hub) rotation compared with that of the five-link design of the known system mentioned above since the axis of rotation of the link is mainly fore and aft rather than mainly lateral. The reduced hub rotation is a benefit for a number of the kinematic and elastokinematic characteristics including toe change with suspension vertical travel.

The invention gives the added benefit of reducing the overall spacing of the suspension system fore and aft since in the five link system mentioned above, the level of hub rotation is a function of the length of the front and rear links.

Another benefit of the wishbone link over five-link arrangements is that is there is one less knuckle attachment (mounting point). A further benefit of the wishbone link is that it provides a suitable mounting point for a stabiliser bar and improves anti-squat characteristics.

Rotational stiffness around the longitudinal link's attachment point to the wheel carrier depends upon the compliance of the wishbone's rearward connection to the vehicle body. Preferably, the bush used at this rearward connection point has a softer rate in the inboard direction than the outboard direction. This ensures high stiffness under braking for good control of the suspension geometry. Bush mouldings having such characteristics are well-known. The closer the wishbone is positioned to wheel centre, in the vertical direction, the stiffer the bush can be made.

The attachment point of the longitudinal link at the wheel carrier may be in line with wheel centre or forward thereof (measured in a horizontal direction).

One of the transverse links may be connected to the wheel carrier forward of wheel centre, while the other transverse link is connected to the wheel carrier rearward of wheel centre (measured in a horizontal direction), with both links being lower links, connected to the wheel carrier below wheel centre. Alternatively, both transverse links may be lower links, with one link being connected to the wheel carrier forward of wheel centre and the other link being connected to the wheel carrier substantially in line with wheel centre.

In further alternative arrangements, one of the transverse links is attached to the wheel carrier forward of and above wheel centre or forward and in line with wheel centre while the other transverse link is attached to the wheel carrier below wheel centre.

One of the transverse links may be configured to support a coil spring or a coil spring and damper assembly or an air spring unit.

The improved packaging efficiency of the present invention helps to maximize rear seat occupancy and boot or trunk package space and shape as well as minimizing the impact of the suspension layout on the body structure. Manufacturing costs can also be less.

While links are referred to herein as either “transverse” or “longitudinal”, it is to be understood that a “transverse” link may have a comparatively small longitudinal component and a “longitudinal” link may have a comparatively small transverse component.

### BRIEF DESCRIPTION OF THE DRAWINGS

Some embodiments of the invention will now be described, by way of example only, with reference to the drawings of which;

FIGS. 1 to 4 show four different perspective views of four suspension links forming a rear suspension for a wheeled vehicle in accordance with a first embodiment.

FIGS. 5 and 6 show two different perspective views of four suspension links forming a rear suspension for a wheeled vehicle in accordance with a second embodiment.

Axes X, Y and Z indicate the angle of view, with the X direction pointing towards the rear of the vehicle.

### DETAILED DESCRIPTION OF THE PREFERRED EMBODIMENTS

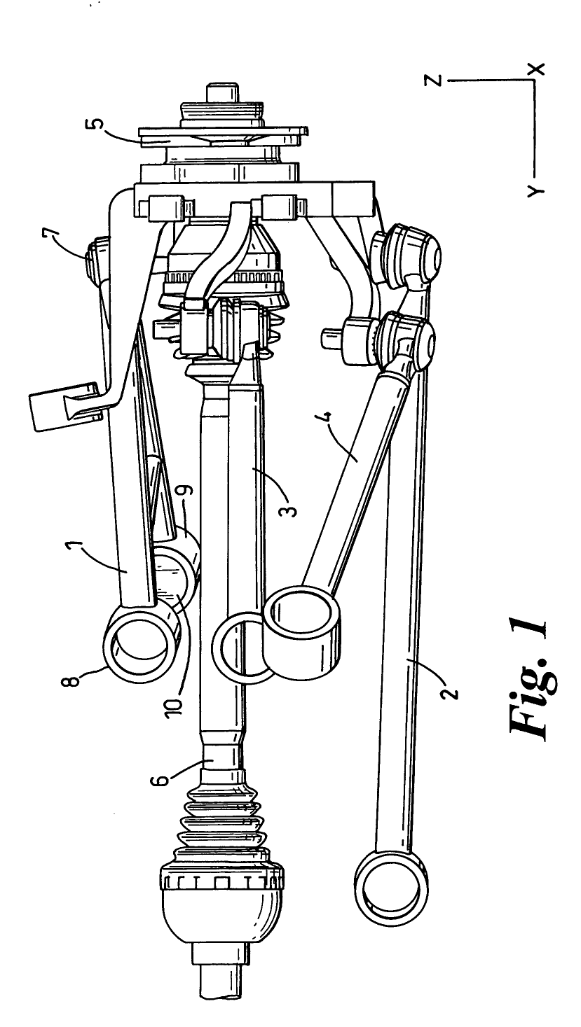

Referring to FIGS. 1 to 4, the rear suspension of this first embodiment comprises an upper transverse wishbone 1, a transverse toe link 2, a transverse control link 3 and a lower, forwardly extending longitudinal link 4. Each of these four links 1 to 4 is mounted between a wheel carrier 5 and the vehicle body or sub-frame (not shown). The wheel carrier 5 is attached to a rear axle 6 of the vehicle.

As is customary, the wheel carrier is also mounted to the vehicle body by means of some spring-loaded device (not shown) to allow vertical movement of the wheel carrier with respect to the vehicle body.

The upper wishbone 1 has a single mounting point 7 at one end where it is connected to the wheel carrier 5, and a pair of mounting points 8, 9 at its other end for connection to the vehicle body.

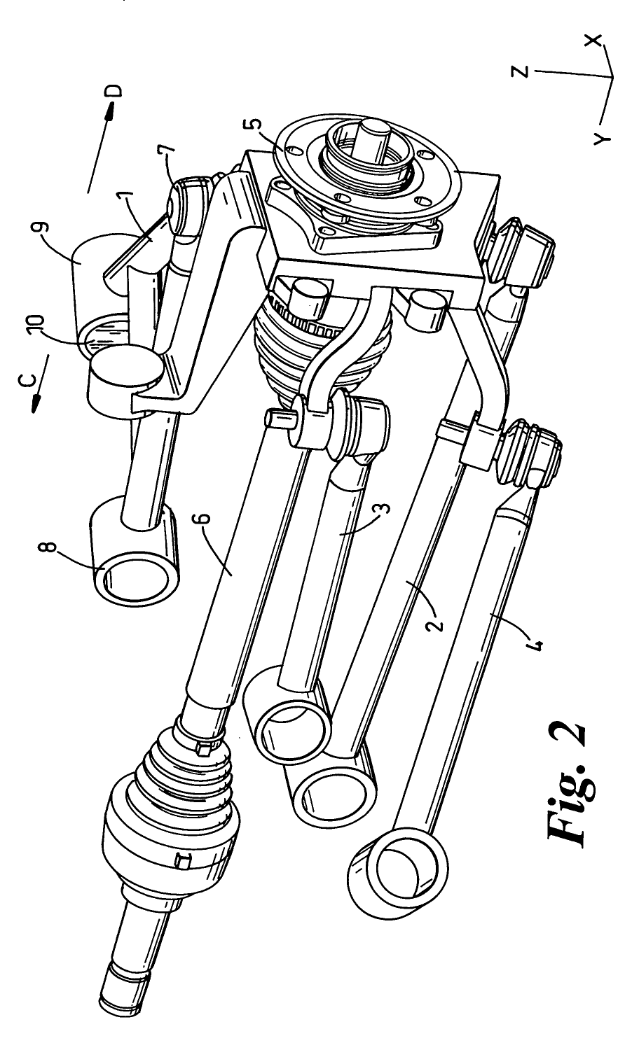

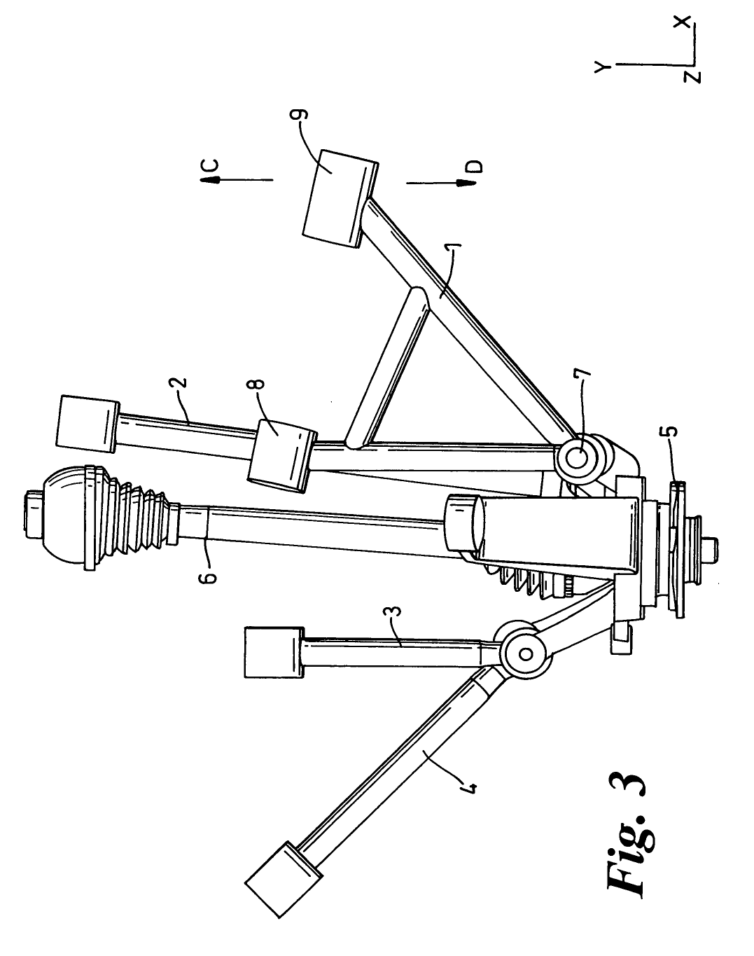

Referring to FIGS. 2 and 3, the rearward mounting point 9 is provided with a resilient bush 10 which has a comparatively soft spring rate in the inboard direction C and a comparatively stiff spring rate in the outboard direction D.

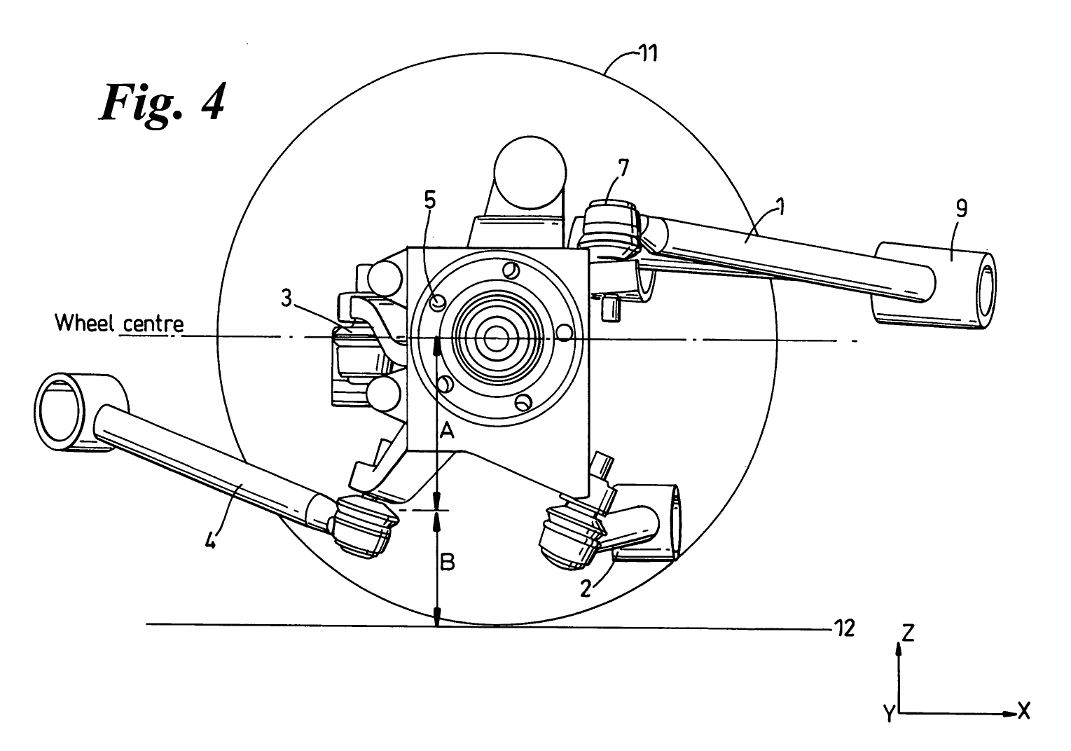

The lower, longitudinal link 4 is mounted to the wheel carrier 5 at a position forward of wheel centre and at a distance ‘A’ from wheel centre measured in the vertical direction that is greater than the distance ‘B’ of this mounting position from the point of contact of the wheel (tyre) (denoted by reference numeral 11 in FIG. 4) and the ground 12.

The transverse toe link 2 is mounted below and rearward of wheel centre.

The transverse control link 3 is mounted substantially in line with wheel centre.

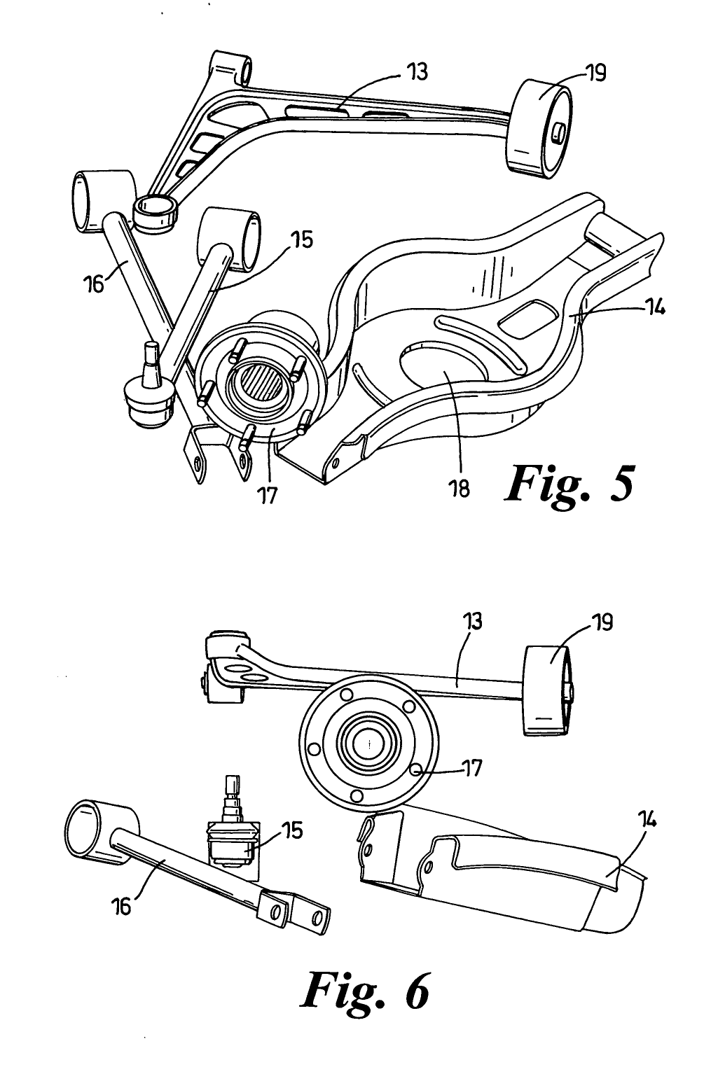

Referring now to FIGS. 5 and 6, a rear suspension for a vehicle comprises an upper arm 13 in the form of a transverse wishbone, a transverse toe link 14, a transverse control link 15 and a lower, forwardly extending longitudinal link 16. Each of the four links are arranged so that they may be mounted at one of their ends to a wheel carrier 17 and at their other ends, to the vehicle body or sub-frame (not shown).

The transverse toe link 14 is a lower link, being connected to the wheel carrier 17 substantially in line with wheel centre. The toe link 14 is further provided with a recess 18 substantially half way along its length for supporting an air spring assembly (not shown).

The transverse control link 15 is a lower link and connected to the wheel carrier forward of wheel centre.

A resilient bush 19 is fitted to the rearward mounting point of the wishbone 13 and has a softer spring rate in the inboard direction than in the outboard direction.

The lower, longitudinal link 16 is mounted to the wheel carrier 17 at a position forward of wheel centre and at a distance from wheel centre measured in the vertical direction that is greater than the distance of this position from the point of contact between the tyre (supported by the wheel carrier 17) and the ground.

Both the above embodiments achieve improved packaging efficiency and minimal twisting forces under braking by virtue of their geometry.

Although the above embodiments have been described for use as a rear suspension system, they could equally well be applied to a front suspension system.

1. A suspension system for a wheeled vehicle having a wheel carrier adapted to support a wheel which has a contact point with the ground, the system comprising four links for connecting the wheel carrier to the vehicle wherein said links comprise an upper arm, two transverse links and a longitudinal link which extends forwardly of the wheel carrier, and wherein the distance between the wheel carrier attachment point of the longitudinal link and wheel centre measured in the vertical direction is greater than the distance between said attachment point and the wheel contact point.

2. A suspension system as claimed in claim 1 in which the upper arm is a transverse wishbone, whose rearward connection to the vehicle is adapted to be stiffer in the outboard direction than the inboard direction.

3. A suspension system as claimed in claim 1 in which the transverse links are connected to the wheel carrier below wheel centre.

4. A suspension system as claimed in claim 1 in which one transverse link is connected to the wheel carrier above wheel centre and the other transverse link is connected to the wheel carrier below wheel centre.

5. A suspension system as claimed in claim 1 in which one of the transverse links (14) is configured to support a coil spring.

6. A suspension system as claimed in claim 1 in which one of the transverse links is configured to support an air spring unit.
